(19) United States
(12) Patent Application Publication
(10) Pub. No.: US 2009/0307103 A1
(43) Pub. Date: Dec. 10, 2009

(54) SYSTEM FOR MANAGING AND FACILITATING FINANCIAL TRANSACTIONS LOCALLY OR REMOTELY MADE

(76) Inventor: Cicero Antonio Xavier De Tortelli, Sao Paulo (BR)

Correspondence Address: STITES & HARBISON PLLC, 1199 NORTH FAIRFAX STREET, SUITE 900, ALEXANDRIA, VA, 22314, US

(21) Appl. No.: 12/162,257

(22) PCT Filed: Apr. 12, 2007
(86) PCT No.: PCT/BR2007/000096

§ 371 Date: Jun. 1, 2009

(30) Foreign Application Priority Data
Sep. 27, 2006 (BR) PI0604416-6

(51) Int. Cl. G06Q 20/00; G06Q 30/00

(52) U.S. Cl. 705/26

(57) ABSTRACT

A financial managing and facilitating system, to be used between a registered shopkeeper or service supplier and a registered customer, using modern information technology. The system allowing a registered customer be asked to approve (or to refuse) an ongoing transaction, even if such operation is being made by a third person duly authorized by the registered customer. The system presents a simplified architecture, being based in three main elements: (1) a customer with or without an authorized dependent; a payment central, such as a credit or debit central managing financial institution; and (3) a registered shopkeeper/service supplier.

### FIELD OF INVENTION

The present invention refers to an inventive solution for a management system of credit or debit, acting as a facilitator agent for commercial transactions between shopkeepers/service suppliers and customers-users, resulting in high quality services, where the consolidation of the purchase and payment by the supplied services is very quick.

### DESCRIPTION OF THE PRIOR ART

Financial operations, such as purchase and sale, have been made since the beginning of history, where we can mention the initial practice of “truck”, or the exchange of goods among people.

This practice was used before the invention of the money, used as an exchange means, being an intermediate instrument of general acceptance, to be received when ceding a good and to be given when acquiring another good (indirect exchange instead of direct exchange). This way, money is used to solve debits and is means for general payment. Money, in this case, must be understood as a monetary unit, translated in the physical form of notes, known as cash, and metallic coins.

With the development of the financial sector, the commercial establishments started to work with another kind of money, the bank checks. The checks were a generalized practice until the end of the 80s, when the technical development, mainly in information technology, experienced an inedited revolution. The commercial automation created the “electronic money”, as magnetic cards, which in the present days are deeply used to replace cash and metallic coin.

Following the evolution cycle, the commercial transactions started to be made, in a great number of commercial establishments, through electronic purchase terminals, due to the easy remote communication between the commercial establishments and the financial institution managing the debits and credits. However, to consolidate these commercial operations with this kind of tool, the customer must be with his/her magnetic card, as the shopkeeper needs to introduce it physically in the electronic payment terminal to start the sale procedures.

Notwithstanding, the use of a magnetic card in the present days presents several negative aspects, where the need of carrying it physically creates misleading and cloning conditions and, consequently, the undue use of the same.

On the other hand, at this time the development of the information technology sector finds no frontiers. Financial transactions have already been made in a remotely way, confirming the trend of progressive substitution of the current physical layouts of the operational systems, by modern layouts, where the remote communication prevails.

In this evolutionary line, the credit management systems are yet sluggish and difficult to operate, compelling the customer to adopt an exhaustively proactive behavior to consolidate the remote financial operation, thus infringing the basic principle of success of a new product. This will prevent the maintenance of a comfort zone previously defined to the customer-user.

Accordingly, besides the accelerated technological advancement of the recent years, the prior art does not teach or describe a remote credit management system, which is of a high quality, agile and practical at the same time.

What is needed therefore is a system allowing financial operations to be consolidated locally, in the commercial establishment (registered), or remotely, aggregating value from the point of view of commodity to the customer-user and shopkeeper, dispensing the need of using a P.O.S. (Point-Of-Sale) terminal by the shopkeeper.

Another advantage of the system of the present invention is that any and all operations have an increased safety value, since the financial operation is only made after authorization, through a password sending (only and exclusively known by the customer-user) to the managing financial institution. The system is also completely reliable, since the managing financial institution compares and checks all and any kind of suspicious operations (different from the customer habits).

The system for managing and facilitating financial transactions of the present invention fully provides the comfort of the customer-user, since the operations are characterized by reactive actions: the customer is only invited to confirm (through a password), or to refuse, the financial operation being processed. The present system is an agile and simple fraud-proof system having low operational cost

### SUMMARY OF THE INVENTION

The present invention seeks to provide a system for managing and facilitating financial transactions comprising: (a) a payment central, having a server equipment with a dedicated software; (b) a remote customer with a limited credit account with the payment central, with a personal password and with a customer identification code; (c) a first wireless communication device (EQ1), activated by the remote customer and able to communicate with the server equipment; (d) a remote shopkeeper or service supplier registered with the payment central, and (e) a second wireless communication device (EQ3), activated by the shopkeeper or service supplier and able to communicate with the server equipment.

The present invention seeks to provide a financial managing and facilitating system, to be used between a registered shopkeeper or service supplier and a registered customer, using modern information technology. The system allows a registered customer be asked to approve (or to refuse) an ongoing transaction, even if such operation is being made by a third person duly authorized by the registered customer. The system presents a simplified architecture, being based in three main elements: (1) customer with or without an (1a) authorized dependent; (2) a payment central, such as a credit or debit central managing financial institution; and a (3) registered shopkeeper/service supplier.

The system of the present invention allows all kinds of financial operations to be restricted to these three elements, which communicate among themselves in a remotely way, using wireless communication, with technological resources such as wireless personal cellphone headsets, a BLUETOOTH (Trademark) for example, infrared, SMS Short Message Service and MMS Multimedia Messaging Service, among others.

### BRIEF DESCRIPTION OF THE DRAWINGS

FIG. 1 shows the architecture of the system for financial transactions in local mode.

FIG. 2 shows the devices used in the architecture of the system for financial transactions.

FIG. 3 shows the architecture of the system for financial transactions in remote mode.

### DETAILED DESCRIPTION OF THE INVENTION

The invention will be described for the purposes of illustration only in connection with certain embodiments; however, it is to be understood that other objects and advantages of the present invention will be made apparent by the following description of the drawings according to the present invention. While a preferred embodiment is disclosed, this is not intended to be limiting. Rather, the general principles set forth herein are considered to be merely illustrative of the scope of the present invention and it is to be further understood that numerous changes may be made without straying from the scope of the present invention.

The present invention includes:

(a) Customer (C.P.), who is the owner of a relationship account with the payment central (C.S.). The customer receives pre-approved credits or credits its own resources to financial operations after due registration and acceptance by the payment central; performs purchase operations; and authorizes (or refuses) payment operations.

The system optionally includes an authorized dependent (C.G.), also known as “non-owner”, who is authorized to make purchase operations, but with the approval from the customer (C.P.).

(b) Payment central (C.S.), intermediates the relationship among commercial establishments and service suppliers and customers; and is responsible for:
(b1) registering the commercial establishments; responsible for granting the limit of financial credit to the customer (C.P.) or managing the credited resources of the customer (C.P.);
(b2) confirmation of all information in connection with the transaction, checking all information in a databank before authorizing or rejecting a sale;
(b3) processing all authorized transactions; responsible for
(b4) evaluating the impacts of the authorized transactions in the shopkeeper and customer accounts;
(b5) managing the customer and shopkeeper accounts, by controlling how much each customer (C.P.) owes to the payment central and how much the payment central owes to the registered commercial establishment or service supplier (L);
(b6) keeping an effective relationship system between the registered commercial establishment or service supplier (L) and the customer (C.P.);
(b7) sending an extract with the summary of the sales to the registered commercial establishment or service supplier (L);
(b8) consolidating the purchase transactions of the customer (C.P.) and sending him/her an invoice for payment;
(b9) assuring total confidentiality and safety during the transactions performed by the system;

(c) Registered commercial establishments or service suppliers (L), which are the establishments receiving payments through the system for managing and facilitating financial transactions. The establishments start the financial transaction of purchase made by the customer (C.P.) or an authorized dependent (C.G.);

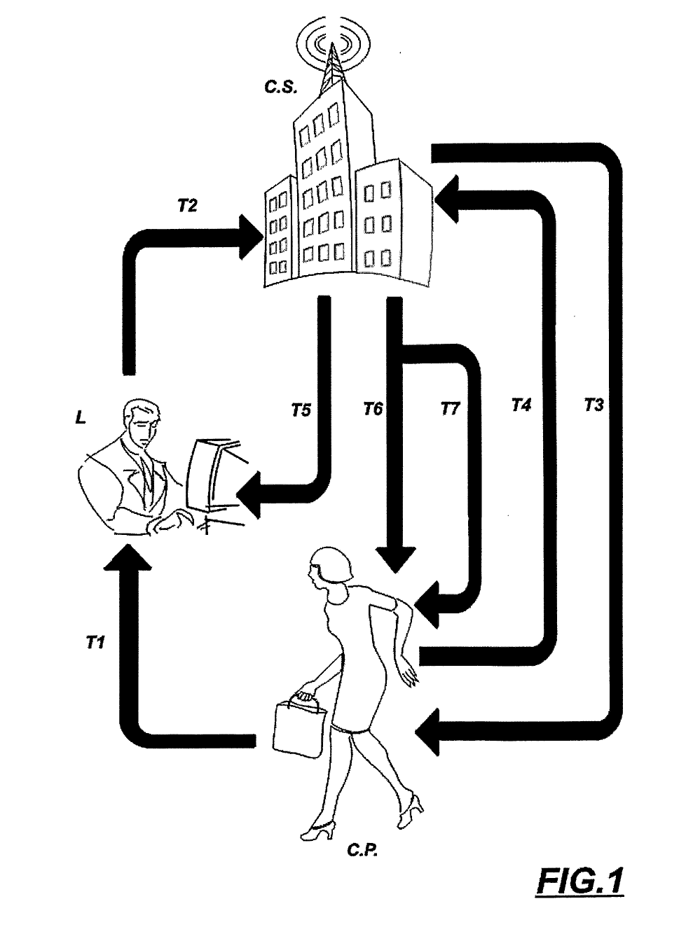

FIG. 1 shows the architecture and basic diagram of a transaction condition made locally, comprising the following operational steps:

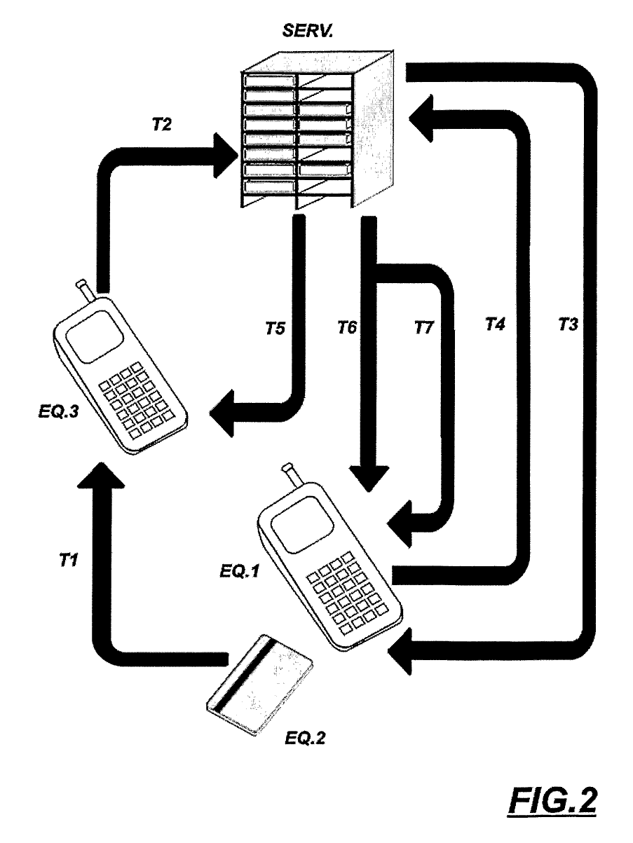

(1) Purchase or payment action of a supplied service (T1) wherein after ending the purchase of a product/service the customer (C.P.) requests the shopkeeper of the registered commercial establishment or service supplier (L) to start the financial transaction of purchase through the system for managing and facilitating financial transactions. During this procedure the customer (C.P.) must provide a customer identification code to the shopkeeper, through a card (EQ2) (see FIG. 2) or orally, the “ ”. This code allows the identification by the payment central (C.S.) of the receiving equipment (EQ1) (see FIG. 2) which will send a notification of the purchase transaction;

(2) Financial transaction (T2), wherein the registered commercial establishment or service supplier (L) sends a signal for the financial transaction to the payment central (C.S.). This signal contains information related to the monetary value of the transaction, payment condition and the customer identification code of the customer (C.P.). From the technological point of view, the financial transaction (T2) may be performed by the shopkeeper through a device (EQ2) (see FIG. 2) which may be any device connected to the payment central (C.S.), such as: a laptop; palmtop; mobile phone; website; mp3-player; mpp4-player; FM-frequency modulation transmitter; software programs that allows users to make telephone calls over the Internet, such as SKYPE (trademark), freeware instant messaging client, such as MSN (trademark); IVR interactive voice response systems; voice command and oral solicitation by phone, among others.

(3) Transaction treatment (T3) wherein when the signal is received by the payment central (C.S.), the information is treated, through a dedicated software that processes the information through a server equipment (SERV) (see FIG. 2) that validates the registered commercial establishment or service supplier (L) and, with the customer identification code, sends the purchase operation order to the equipment (EQ1) of the customer (C.P.). Again, from the technological point of view, the equipment (EQ1) may be understood as any device (see FIG. 2) that is connected to the payment central (C.S.), such: a laptop; palmtop; mobile phone; website; mp3-player; mp4-player; FM-frequency modulation transmitter; software programs that allows users to make telephone calls over the Internet, such as SKYPE (trademark), freeware instant messaging client, such as MSN (trademark);

(4) Operation consolidation (T4) wherein the customer (C.P.) receives a notification to answer a call in his/her equipment (EQ1), where he/she is informed about the present purchase request. The notification includes information on the transaction amount, payment option and the registered commercial establishment or service supplier (L), which generates the operation.

After knowing the nature and details of the purchase operation, the customer (C.P.) defines if he/she accepts the operation (through entering a secret password), or not. In a negative case he/she informs the system by selecting, for example, the correct option of the menu.

The consolidation is characterized by the direct and reactive action of the customer (C.P.), without the complexity translated by the need of entering the data to confirm the register, research, delay in open line, etc, well known in solutions of this nature, provide by the prior art.

(5) Purchase confirmation (T5), wherein when receiving the operation acceptance (the customer personal password), the payment central (C.S.) validates the sent password using the dedicated software of information management in the server equipment (SERV.). After the validation a notification of the purchase confirmation is sent to the registered commercial establishment or service supplier (L) that generated the operation. The payment central (C.S.) automatically transmits the payment for the purchase operation to the registered commercial establishment or service supplier (L), in accordance with the contract previously agreed between the parts.

(6) Notification of purchase confirmation (T6) wherein a notification of purchase confirmation is sent to the customer (C.P.); and

(7) Invoice issuance (T7) wherein after confirming and consolidating the purchase operation, the payment central (C.S.) issues an invoice to the customer (C.P.), for posterior payment, in accordance with the contract previously agreed between the parts.

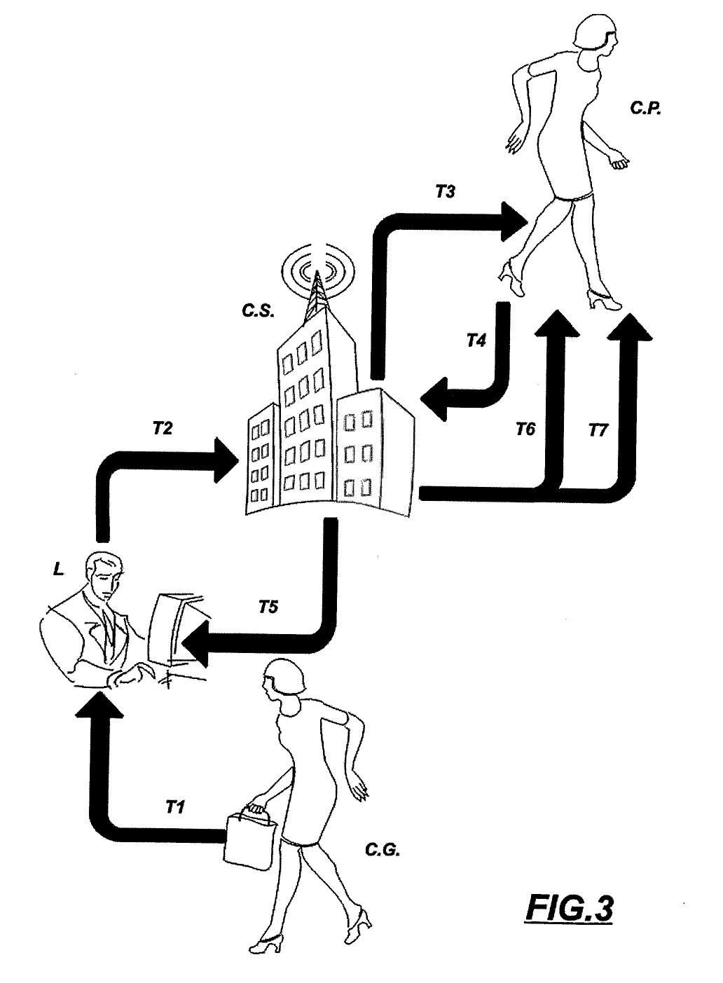

In FIG. 3, a second operational condition is presented, where the purchase transaction is made by an authorized dependent (C.G.), which is a “non-owner” user previously authorized by the customer (C.P.).

In this condition an aggregated advantage of the new system is evident, where the purchase may be made by a third party, an authorized dependent (C.G.), where the customer (C.P.), remotely located, authorizes the operation consolidation (T4).

1. A system for managing and facilitating financial transactions comprising:
(a) a payment central, having a server equipment with a dedicated software;
(b) a remote customer with a limited credit account with the payment central, with a personal password and with a customer identification code;
(c) a first wireless communication device, activated by the remote customer and able to communicate with the server equipment;
(d) a remote shopkeeper or service supplier registered with the payment central, and
(e) a second wireless communication device, activated by the shopkeeper or service supplier and able to communicate with the server equipment.

2. (canceled)

3. The system according to claim 1, wherein the first and second wireless communication devices are selected from the group consisting of: frequency modulation transmitter; software programs that allows users to make telephone calls over the Internet; freeware instant messaging client; interactive voice response systems; voice command and oral solicitation by phone.

4. The system according to claim 1, wherein the purchase action comprises the steps of:
(T1) the customer performing a purchase operation with the shopkeeper or service supplier;
(T2) the registered commercial establishment or service supplier sending a signal for the financial transaction to the payment central, the signal containing a monetary value of the transaction, payment conditions and the customer identification code of the customer:
(T3) the payment central validating the registered commercial establishment or service supplier and the customer identification code, and sending a purchase operation order to the first wireless communication device of the customer;
(T4) the customer receiving a notification in the first wireless communication device informing the purchase request, including the monetary value of the transaction, payment conditions and the registered commercial establishment or service supplier;
(T5) the customer accepting or refusing the transaction by a direct and reactive action through a correct selection on a menu; wherein the customer when accepting the transaction, entering the personal password; the payment central validating the password, sending a notification of the purchase confirmation to the registered commercial establishment or service supplier and automatically transmitting a payment for the purchase operation to the registered commercial establishment or service supplier;
(T6) the payment central sending a notification of purchase confirmation to the customer; and
(T7) the payment central issuing an invoice to the customer, for posterior payment.

5. The system according to claim 1, wherein in the customer provides a customer identification code to the registered commercial establishment or service supplier, through a card or orally.

6-14. (canceled)

15. The system according to claim 1, optionally comprising a remote authorized dependent, authorized to perform a purchase operation with the shopkeeper or service supplier make, with an approval from the customer.

16. The system according to claim 1, further including the payment central sending an extract with the summary of the sales to the registered commercial establishment or service supplier after consolidating the purchase transaction.
